(19) United States
(12) Patent Application Publication
(10) Pub. No.: US 2020/0376924 A1
(43) Pub. Date: Dec. 3, 2020

(54) Vehicle Under Mounted HVAC Container

(71) Applicant: WEBTEZ, INC., Oxnard, CA (US)

(72) Inventors: Peter J. Tezza, II, Oxnard, CA (US); Michael Brian Pohmisano, Oxnard, CA (US)

(21) Appl. No.: 15/929,882

(22) Filed: May 27, 2020

Related U.S. Application Data
(60) Provisional application No. 62/856,057, filed on Jun. 1, 2019.

(51) Int. Cl. B60H 1/00; B62D 25/20

(52) U.S. Cl. CPC B60H 1/00535; B60H 1/00542; B62D 25/20

(57) ABSTRACT

A container for mounting under a vehicle floor, the container comprising: a plurality of side walls, wherein the plurality of side walls have a plurality of openings; a top wall is attached to a top portion of the plurality of side walls, wherein the top wall is attached to the vehicle floor; a removable floor is attached to a bottom portion of the plurality of side walls; a cavity defined by the plurality of side walls, the top wall, and the floor, wherein the cavity contains an HVAC apparatus. The container further comprising: a plurality of ducts comprising a plurality of first ends connected to the plurality of openings in the plurality of side walls; and, a plurality of second ends connected to a plurality of outputs; wherein air from the HVAC apparatus flows through the plurality of ducts from the plurality of openings to the plurality of outputs.

### CROSS-REFERENCE TO RELATED APPLICATIONS

This application is a non-provisional of, and claims the benefit of priority from, U.S. Provisional Patent Application No. 62/856057 filed Jun. 1, 2019.

### FEDERALLY SPONSORED RESEARCH

Not Applicable

### FIELD OF INVENTION

This invention relates to vehicle under mounted container, more particularly, to vehicle under mounted container for holding a variety of heating ventilation and air conditioning (HVAC) apparatuses.

### BACKGROUND

Heaters, air-conditioners and other air conditioning appliances are installed in vehicles to improve passenger comfort. These appliances are typically mounted inside the vehicle or on the roof of the vehicle. Appliances located within the vehicle occupy limited interior space and increase noise within the interior space, which can cause irritation to the driver and passengers. Some vehicles overcome these draw backs by mounting the appliances on the roof. The drawback for mounting appliances on the roof: increases the overall height of the vehicle and in turn increases potential damage to the roof from overhead structures; and, raises the center of gravity of the vehicle, which decreases vehicle stability around turns and windy roads.

Some recreational vehicles (RVs) have RV specific furnaces that are directly mounted under the vehicle floor. However, these furnaces are more expensive then typical appliances, limited in mounting options, limited in heating capacity, limited in availability, and are not approved by the United States RV manufactures. There is a need for a container to capable of being mounted under a vehicle floor that is able to hold a variety of HVAC appliances.

### BRIEF SUMMARY OF THE INVENTION

A container for mounting under a vehicle floor, the container comprising: a plurality of side walls, wherein the plurality of side walls have a plurality of openings; a top wall is attached to a top portion of the plurality of side walls, wherein the top wall is attached to the vehicle floor; a removable floor is attached to a bottom portion of the plurality of side walls; a cavity defined by the plurality of side walls, the top wall, and the floor, wherein the cavity contains an HVAC apparatus. The container further comprising: a plurality of ducts comprising a plurality of first ends connected to the plurality of openings in the plurality of side walls; and, a plurality of second ends connected to a plurality of outputs; wherein air from the HVAC apparatus flows through the plurality of ducts from the plurality of openings to the plurality of outputs; a plurality of pipes, wherein the plurality of pipes comprise of at least one of a water pipe and a gas pipe; at least one electrical connector; and at least one control connector.

### BRIEF DESCRIPTION OF THE DRAWINGS

FIG. 1A is a bottom facing perspective view showing a container attached under the vehicle floor, FIG. 1B is a side view of the container, and FIG. 1C is a cutaway view of FIG. 1B at section AA of the container depicting the HVAC apparatus.

FIG. 2 is a top facing perspective view of the container without the vehicle floor.

FIGS. 3A is a bottom facing perspective of a floor opening of the container and 3B is a cutaway view of the container showing a drain fitting secured in the floor opening.

FIG. 4 is an exploded view of a removable floor attached to the container.

FIG. 5 is a top exploded view of a water pump attached to the container.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art.

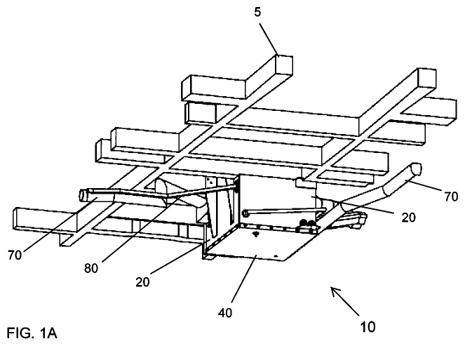

FIGS. 1A-1B show a non-limiting example of a container 10 mounted to a vehicle 1 embodying this invention may have a plurality of side walls 20, a top wall 30, and a floor 40. The container 10 may be mounted under or to the bottom of the vehicle floor 5, where the vehicle floor 5 may include a vehicle chassis, a vehicle frame, and/or a vehicle floor board. In the preferred embodiment, the container 10 may be mounted to a recreational vehicle (RV), which may have an increase clearance from the bottom of the vehicle floor 5 to a ground surface. In most embodiments, the container 10 is made from one or more metals such as steel, stainless steel, galvanized steel, aluminum, etc. In other embodiments, the container 10 is made from one or more hard plastics such as high-density polyethylene, acetal or polyoxmethylene, high impact polystyrene, polyetheretherketone, etc.

In some embodiments, the position of the container 10 may be modular, where the container 10 may be moved as a unit from a first location under the vehicle floor 5 to a second location under the vehicle floor 5. In most embodiments, the top wall 30 of the container 10 may be attached to the vehicle floor 5 by any conventional fastening means, such as bolts, screws, clips, pins, snap-fits, etc. In a preferred embodiment, the container 10 may be positioned and attached to the vehicle floor 5 in front of a rear axle of the vehicle 1 with a twelve inch clearance to prevent collision with the rear axle. In some embodiments, two or more containers 10 may be attached at a plurality of attachment points under the vehicle floor 5, where each container 10 may service at least one interior area of the vehicle 1, such as the driver's compartment, front passenger compartment, rear passenger compartments, and/or storage areas.

In most embodiments, a cavity 50 may be defined by the plurality of side walls 20, the top wall 30, and the floor 40. The cavity 50 may hold an Heating, Ventilation, and Air Conditioning (HVAC) apparatus 60 as seen in FIG. 1C. The HVAC apparatus may be at least one of a heater, and air conditioner, a refrigerator, a compressor, a heat pump, a dehumidifier, and a purifier. The HVAC apparatus may be changed to fit the needs of the vehicle owner and any HVAC apparatus can be use. By placing the container 10 underneath the vehicle floor 5, the noise generated by the HVAC apparatus 60 may be reduced because of the increased distance between the HVAC apparatus 60 and the interior of the vehicle 1.

In some embodiments, one or more HVAC apparatuses 60 may be placed within the cavity 50. In other embodiment, a hybrid HVAC apparatus may be placed within the cavity 50 of the container 10 that is made up of one or more HVAC apparatus listed above. In most embodiments, the cavity 50 may have fasteners 52 to secure the HVAC apparatus 60 within the cavity. In other embodiments, the cavity 50 may be sized to securely fit the HVAC apparatus 60 without the need for fasteners, where the plurality of walls 20 may prevent any horizontal or vertical movement of the HVAC apparatus 60 while moving or driving the vehicle 1.

Referring back to the modular container embodiments, a non-limiting example of how the modular containers may be use within different compartments will be described. The hybrid HVAC apparatus made up of an air conditioner and heater combo may be placed in the cavity 50 of the container 10 that is mounted near the front of the vehicle to service the driver and the passengers, where as the HVAC apparatus acting as a refrigerator may be placed in the cavity 50 of a container 10 that is mounted near the rear of the vehicle to service a freezer box within the interior space of the vehicle 1. This example may apply to a food truck or an RV use for hunting and fishing.

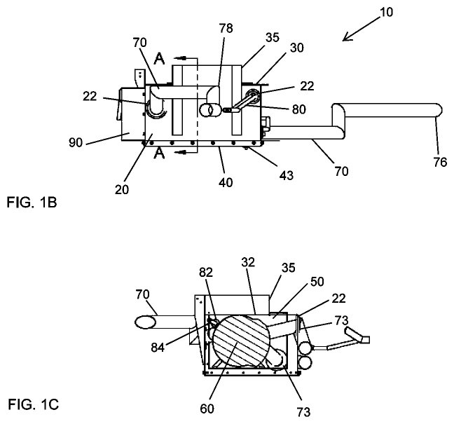

Looking at FIGS. 1B-1C and 2, the plurality of side walls 20 may have a plurality of openings 22. In some embodiments, the plurality of openings 22 may connect to a plurality of first ends 72 of a plurality of ducts 70. In some embodiments, the plurality of ducts 70 may be made of one or more plastics, one or more metals, or a combination thereof. In a non-limiting example, the plurality of ducts 70 may be made of PVC tubing or aluminum ventilation tubing. In some embodiments, at least one of the plurality of ducts 70 may pass through at least one of the plurality of openings 22 to directly connect with the HVAC apparatus 60. In other embodiments, at least one of plurality of first ends 72 of the plurality of ducts 70 may be connected to a first end of a duct connector 73 that may be secured within at least one of the plurality of openings 22. In some embodiments, a second end of the duct connector 73 may be directly connected to the HVAC apparatus 60. In other embodiments, the second end of the duct connector 73 may be connected to an output manifold or individual output ducts that may be connected to the HVAC apparatus 60.

In another example, a first part of the duct 70 located under the vehicle may be made of hard or solid tubing, such as PVC tubing or galvanized steel tubing, and a second part of the duct 70 located within a vehicle wall 2 may be made of an elastic tubing, such as an aluminum dryer vent tubing or flexible plastic tubing. This way, the first portion of the duct 70, which may be positioned under the vehicle, may be more resistant to damage while the second portion of the duct 70 may be highly flexible and readily shaped to be positioned within the vehicle walls 2, where damage resistance is less necessary.

In some embodiments, a plurality of second ends 74 of the plurality of ducts 70 may be connected to a plurality of outputs 76. In most embodiment, the plurality of outputs 76 may be positioned within the vehicle 1. The plurality of outputs 76 may be positioned within at least one of the vehicle wall 2, the vehicle floor 5, a vehicle ceiling, a vehicle console, a vehicle dashboard, and a piece of vehicle furniture. In one embodiment, the plurality of outputs 76 are positioned to face outside the vehicle 1. Such embodiment may be used to accommodate special effects like a fog machine or a fragrance dispenser apparatus for a food truck.

In some embodiments, the plurality of duct 70 may be structured to include a catch 78. The catch 78 may be structured to prevent a fluid, condensation, debris, or a combination thereof from entering the cavity 50 of the container 10. The catch 78 may prevent corrosion or debris from building up within the cavity 50 or interference with the HVAC apparatus 60, which would extend the life of both the container 10 and the HVAC apparatus 60.

Referring to FIG. 2, in some embodiments the plurality of openings 22 may be of different sizes, where at least one of the plurality of openings 22 may be connected to at least one a plurality of input pipes 80. In some embodiments, the plurality of input pipes 80 may be at least one of a fluid pipe and a gas pipe. In most embodiments, the fluid pipe may convey combustible fluids such as gas or noncombustible fluids such as water, where as the gas pipe may convey typical gases such as propane, natural gas, oxygen, air, or a combination thereof. In some embodiments, at least one of the plurality of input pipes 80 may be connected to at least one of an input connector 82 secured within at least one of the plurality of openings 22. The input connector 82 may be any type of connector, including but not limited to a compression connector or valve connector.

In some embodiments, the HVAC apparatus 60 may be connected by a flexible input pipe 84 that may be connected to an end of the input connector 82 located within the cavity 50. In other embodiments, the input connector 82 may be directly connected to the HVAC apparatus 60. In some embodiments, the plurality of input pipes 80 may be directly connected to the HVAC apparatus 60 through at least one of the plurality of openings 22.

In most embodiments, the container 10 may have an electrical input connection 84, not shown. The electrical input connection 84 may connect the HVAC apparatus 60 to a battery or power source produced by the engine of the vehicle 1. The electrical input connection 84 may also connect the HVAC apparatus 60 to a non-vehicle source of power, such as a typical power outlet.

In most embodiments, the container 10 may also have a control input connection 86, not shown. The control input connection 86 may connect the HVAC apparatus 60 to a user interface device 88, not shown. In some embodiments, the user interface device 88 may be located within the interior of the vehicle 1, including but not limited to at least one of the vehicle walls 2, the vehicle dashboard, the vehicle console, and the piece of vehicle furniture. The user interface device 88 may be integrated or a stand alone input device. In some embodiments, the control input connection 86 may be connected to a wireless device that may be connected to the user interface device 88, such as a dashboard interface, a computer, a tablet, a smartphone, etc. In other embodiments, the HVAC apparatus 60 may have a built in wireless device, such as Bluetooth, which may be connected to a Bluetooth system of the vehicle 1 or the user interface device 88 listed above.

Referring to FIG. 2, in most embodiments, the top wall 30 may have a top opening 32 that may be connected to a vehicle floor vent opening 34 located on the vehicle floor 5. In most embodiments, the HVAC apparatus may receive air from the interior of the vehicle 1 through the vehicle floor vent opening 34 into the top opening 32 and into the cavity 50 of the container 10. In most embodiments, the cavity 50 may serves as an air return plenum. In other embodiments, air received through the vehicle floor vent opening 34 may be directly connected to an air intake port on the HVAC apparatus 60 by a vent duct 35, that passes through the top opening 32. In most embodiments, the vehicle floor vent opening 34 is covered by a vent cover 36, which may be made of various materials such as one or more plastics, one or more metals, or a combination thereof. The vent cover 36 may be sturdy enough to prevent damage from the user or may prevent a part of the user's body from falling through the vehicle floor vent opening 34. In some embodiments, the vehicle floor vent opening 34 may be reduced or shaped to prevent a part of the user's body from falling through the vehicle floor vent opening 34. In other embodiments, a vehicle vent opening 38 may be positioned within at least one of the vehicle wall 2, the vehicle ceiling, the vehicle console, the vehicle dashboard, and the piece of vehicle furniture. Where the vehicle vent opening 38 may be connected to the top opening 32 by the vent duct.

In some embodiments, the container 10 may be weatherproof. This may be accomplished by placing seals around the plurality of openings 22, a perimeter of the top wall 30, a perimeter of the top opening 32, and a perimeter of the floor 40. In some embodiments, the duct connectors 73, the input connectors 82, the electrical connection 84, and the control connection 86 may act as a weatherproofing seal. In some embodiments, the bottom portion of the plurality of walls 22 may have an inclined protrusion or skirt just above the floor 40. The inclined protrusion or skirt may prevent fluids or debris from collecting on at least one of an edge of the bottom portion of the plurality of side walls 20 connected to the floor 40.

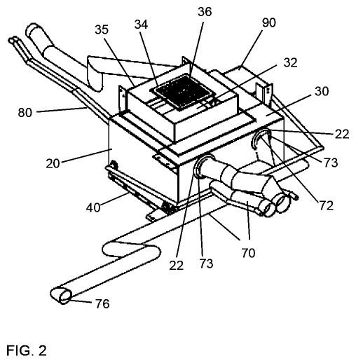

Referring to FIG. 3A, in most embodiments, the floor 40 may have a floor opening 42 that may allow for fluid withing the container 10 to drain through the floor opening 42. In some embodiments, the floor opening 42 may have a beveled edge facing away from the cavity 50 of the container 10 to prevent water from entering the floor opening 42. In some embodiments, a drain fitting 43 may be secured into the floor opening 42, where the drain fitting 43 secures a drain tube 63 connected to the HVAC apparatus 60 to and through the floor opening 42, as seen in FIG. 3B, so that a HVAC fluid drains from the HVAC apparatus 60 through the drain tube 63 to an outside environment. The floor opening 42 may prevent corrosion of an interior surface of the cavity 50 caused by a build up of fluid or condensation within the container 10, which may extend the life span of the container 10.

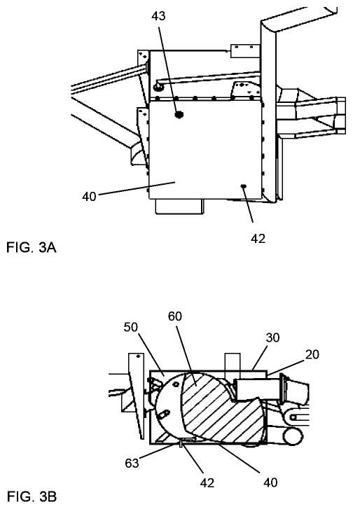

Referring to FIG. 4, the floor 40 may be a removable floor 41 so that the HVAC apparatus 60 may be serviced on location or removed for service or replacement at another location. In some embodiments, the removable floor 41 may have a protruding rim 45 on at least one side of the removable floor 41. The protruding rim 45 may have a plurality of rim holes 46 that align with a plurality of bottom fastener holes 26 located on the bottom portion of at least one of the plurality of side walls 20. In most embodiments, a plurality of bottom fasteners 48 may be inserted through the plurality of rim holes 46 and the aligned plurality of bottom fasteners 48. The plurality of bottom fasteners 48 may be any type of fastener such as screws, bolts, clips, pins, snap-fits, etc. In some embodiments, the plurality of bottom fasteners holes 26 and the plurality of rim holes 46 may be threaded for bolts or screws fasteners. In some embodiments, the plurality of bottom fasteners holes 26 and the plurality of rim holes 46 may be shaped to securely hold a bolt or a nut. In some embodiments, the floor 40 may be hinged to at least one of the plurality of walls 20.

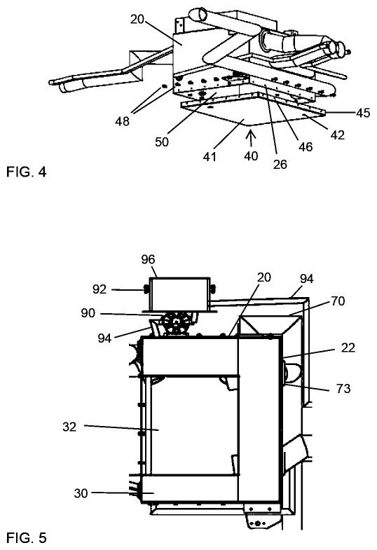

Referring to FIG. 5, in some embodiments, the container 10 may have a water pump 90 that may be attached within the cavity 50 or outside of the container 10 on one of the plurality of side walls 20 by water pump fasteners 92. In some embodiments, water pump pipes 94 may follow the ducts 70 to reduce the amount of openings in the interior of the vehicle 1. In some embodiments, the water pump 90 may be covered by a removable protective cover 96 attached to the same one of the plurality of side walls 20 as the water pump 90 by water pump cover fasteners 98. The water pump cover 96 may help prevent damage to the water pump 90 by protecting said pump from external elements or debris.

In particular, with respect to the above description, it is to be realized that the optimum dimensional relation ships for the parts of the present invention may include variations in size, materials, shape, form, function and manner of operation. The assembly and use of the present invention are deemed readily apparent and obvious to one skilled in the art.

1. A container for mounting under a vehicle floor, the container comprising:
a plurality of side walls, wherein the plurality of side walls have a plurality of openings;
a top wall is attached to a top portion of the plurality of side walls, wherein the top wall is attached to the vehicle floor;
a floor is attached to a bottom portion of the plurality of side walls;
a cavity defined by the plurality of side walls, the top wall, and the floor, wherein the cavity contains an HVAC apparatus.

2. The container of claim 1, wherein the top wall has a top opening; wherein the top opening is connected to a vehicle floor vent opening on the vehicle floor.

3. The container of claim 2, wherein the HVAC apparatus receives air through the vehicle floor vent opening and the top opening into the cavity of the body, wherein the cavity serves as an air return plenum.

4. The container of claim 1, wherein the HVAC apparatus is at least one of an air conditioner, a heater, and a dehumidifier.

5. The container of claim 1, wherein the container is weatherproof.

6. The container of claim 1, further comprising:
a plurality of ducts comprising a plurality of first ends connected to the plurality of openings in the plurality of side walls; and, a plurality of second ends connected to a plurality of outputs;
wherein air from the HVAC apparatus flows through the plurality of ducts from the plurality of openings to the plurality of outputs;
a plurality of pipes, wherein the plurality of pipes comprise of at least one of a water pipe and a gas pipe;
at least one electrical connector; and
at least one control connector.

7. The container of claim 6, wherein the plurality of outputs are positioned within at least one of a vehicle wall, the vehicle floor, a vehicle ceiling, a vehicle console, and a piece of vehicle furniture.

8. The container of claim 1, wherein at least one of the plurality of ducts form at least one catch, wherein the at least one catch prevents at least one of a fluid, condensation, and debris from entering the cavity of the container.

9. A modular container for mounting under a vehicle floor, the modular container comprising:
a plurality of side walls, wherein the plurality of side walls have a plurality of openings;
a top wall is attached to a top portion of the plurality of side walls, wherein the top wall is attached to the vehicle floor;
a removable floor is attached to a bottom portion of the plurality of side walls;
a cavity defined by the plurality of side walls, the top wall, and the floor, wherein the cavity contains a plurality of fasteners for holding an HVAC apparatus;
wherein the top wall of the modular container is positioned in at least one mounting spot.

10. The modular container of claim 9, wherein the top wall has a top opening; wherein the top opening is connected to a vehicle floor vent opening on the vehicle floor.

11. The modular container of claim 10, wherein the HVAC apparatus receives air through the vehicle floor vent opening and the top opening into the cavity of the body, wherein the cavity serves as an air return plenum.

12. The modular container of claim 9, wherein the HVAC apparatus is at least one of an air conditioner, a heater, a dehumidifier, and an purifier.

13. The modular container of claim 9, wherein the container is weatherproof.

14. The modular container of claim 8, further comprising:
a plurality of ducts comprising a plurality of first ends connected to the plurality of openings in the plurality of side walls; and, a plurality of second ends connected to a plurality of outputs;
wherein air from the HVAC apparatus flows through the plurality of ducts from the plurality of openings to the plurality of outputs.
a plurality of pipes, wherein the plurality of pipes comprise of at least one of a water pipe and a gas pipe;
at least one electrical connector; and
at least one control connector.

15. The modular container of claim 14, wherein the plurality of outputs are positioned within at least one of a vehicle wall, the vehicle floor, a vehicle roof, a vehicle console, and a piece of vehicle furniture

16. The modular container of claim 9, wherein the removable floor has a floor opening to drain a fluid within the container.

17. The modular container of claim 16, wherein the floor opening secures a drain fitting;
wherein the drain fitting secures a drain tube connected to the HVAC apparatus to and through the floor opening; wherein a HVAC fluid drains out of the HVAC apparatus through the drain tube that is secured in the floor opening to an outside environment.

18. The modular container of claim 9, wherein the removable floor has a protruding rim, where the protruding rim has a plurality of rim holes that align with a plurality of bottom fastener holes located on the bottom portion of the plurality of side walls; when the removable floor is attached to the bottom portion of the plurality of the side walls by a plurality of bottom fasteners inserted through each of the plurality of rim holes and the plurality of bottom fastener holes, respectively.

19. The modular container of claim 9, wherein the removable floor has a hinged side connected to one of the plurality of side walls.

20. The modular container of claim 9, further comprising:
a water pump, wherein the water pump is attached to one of the plurality of side walls;
a water pump cover fitted to cover the water pump, wherein the water pump cover is attached to one of the plurality of side walls.
